(19) United States
(12) Patent Application Publication
(10) Pub. No.: US 2021/0247899 A1
(43) Pub. Date: Aug. 12, 2021

(54) METHOD OF DISPLAYING USER INTERFACE, TERMINAL DEVICE AND STORAGE MEDIUM

(71) Applicant: SZ DJI TECHNOLOGY CO., LTD., Shenzhen (CN)

(72) Inventors: Guanliang Su, Shenzhen (CN); Genyuan Wang, Shenzhen (CN)

(21) Appl. No.: 17/242,298

(22) Filed: Apr. 27, 2021

Related U.S. Application Data
(63) Continuation of application No. PCT/CN2018/112840, filed on Oct. 31, 2018.

(51) Int. Cl. G06F 3/0488; G06F 3/0483; G06F 3/0484

(52) U.S. Cl. CPC G06F 3/04883; G06F 2203/04108; G06F 3/0484; G06F 3/0483

(57) ABSTRACT

Method, terminal device, and storage medium of displaying a user interface are provided. The method includes obtaining an initial contact point of a user on a display component, the display component including two or more different position areas; determining a position area to which the initial contact point belongs in the display component based on position information of the initial contact point on the display component, the two or more different position areas corresponding to different angle thresholds; and controlling the user interface to display in the display component, based on a sliding operation of the user starting from the initial contact point and an angle threshold corresponding to the position area to which the initial contact point belongs in the display component.

### CROSS-REFERENCE TO RELATED APPLICATIONS

This application is a continuation of International Application No. PCT/CN2018/112840, filed on Oct. 31, 2018, the entire content of which is incorporated herein by reference.

### TECHNICAL FIELD

The present disclosure relates to the technical field of computers and, more specifically, to a method of displaying a user interface, a terminal device, and a storage medium.

### BACKGROUND

Products such as smart watches, small cameras, and miniature electronic products have relatively small display components (e.g., screens). The screen is generally a touch screen, and the user can switch the displayed interface on the touch screen through touch operations.

Often, the user's sliding direction on the touch screen is used to determine the user interface that the user wishes to remove or display. For example, an angle threshold, such as 45°, can be preset. When the angle between the user's sliding direction on the touch screen and the horizontal direction is greater than 45°, it is determined that the user interface that the user wishes to remove or display is the upper and lower pages. When the angle between the user's sliding direction on the touch screen and the horizontal direction is less than 45°, it is determined that the user interface that the user wishes to remove or display is the left and right pages.

However, when the screen size is small, the user's sliding direction on the touch screen can easily be incorrectly determined, causing the small screen product to fail to display the accurate user interface.

### SUMMARY

One aspect of the present disclosure provides a method of displaying a user interface, including obtaining an initial contact point of a user on a display component, the display component including two or more different position areas; determining a position area to which the initial contact point belongs in the display component based on position information of the initial contact point on the display component, the two or more different position areas corresponding to different angle thresholds; and controlling the user interface to display in the display component, based on a sliding operation of the user starting from the initial contact point and an angle threshold corresponding to the position area to which the initial contact point belongs in the display component.

Another aspect of the present disclosure provides a terminal device, including a display component; a processor; and a memory storing program instructions that, when being executed by the processor, cause the processor to obtain an initial contact point of a user on a display component, the display component including two or more position areas; determine a position area to which the initial contact point belongs in the display component based on position information of the initial contact point on the display component, the two or more different position areas corresponding to different angle thresholds; and control the user interface to display in the display component, based on a sliding operation of the user starting from the initial contact point and an angle threshold corresponding to the position area to which the initial contact point belongs in the display component.

Another aspect of the present disclosure provides a non-transitory computer-readable storage medium containing a computer program stored therein, and when being executed by the processor, configured to cause the processor to obtain an initial contact point of a user on a display component, the display component including two or more position areas; determine a position area to which the initial contact point belongs in the display component based on position information of the initial contact point on the display component, the two or more different position areas corresponding to different angle thresholds; and control the user interface to display in the display component, based on a sliding operation of the user starting from the initial contact point and the angle threshold corresponding to the position area to which the initial contact point belongs in the display component.

Additional aspects and advantages of the technical solutions of the present disclosure will be partially provided in the following descriptions, and partially become obvious from the following descriptions. Alternatively, the additional aspects and advantages of the technical solutions can be understood from practicing the various embodiments of the present disclosure.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a method of displaying a user interface according to an embodiment of the present disclosure.

FIG. 2 is a schematic diagram of a terminal device display component according to an embodiment of the present disclosure.

FIG. 3 is a schematic diagram of the terminal device display component according to an embodiment of the present disclosure.

FIG. 4 is a flowchart of schematic diagram of the method of displaying the user interface according to another embodiment of the present disclosure.

FIG. 5 is a schematic diagram of the terminal device display component according to another embodiment of the present disclosure.

FIG. 6 is a schematic diagram of the terminal device display component according to another embodiment of the present disclosure.

FIG. 7 is a schematic diagram of the terminal device display component according to another embodiment of the present disclosure.

FIG. 8 is a schematic diagram of the terminal device display component according to another embodiment of the present disclosure.

FIG. 9 is a schematic diagram of the terminal device display component according to another embodiment of the present disclosure.

FIG. 10 is a schematic diagram of the terminal device display component according to another embodiment of the present disclosure.

FIG. 11 is a flowchart of schematic diagram of the method of displaying the user interface according to another embodiment of the present disclosure.

FIG. 12 is a flowchart of schematic diagram of the method of displaying the user interface according to another embodiment of the present disclosure.

FIG. 13 is a structural diagram of the terminal device according to an embodiment of the present disclosure.

### REFERENCE NUMERALS

1 Direction
2 Direction
3 Direction
4 Direction
20 Display component
21 Left edge
22 Right edge
23 Upper edge
24 Lower edge
51 To-be-displayed user interface
511 Partial page
512 Partial page
71 Partial page
130 Terminal device
131 Memory
132 Processor
133 Display component

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

It should be noted that, when one component is referred to as “fixed to” another component, it may be directly on another component or it is also possible that there is a third component between them. When one component is considered to “connect” another component, it may be directly connected to the other component or it is possible that there is a third component between them.

Unless otherwise defined, all the technical and scientific terms used in the present disclosure have the same or similar meanings as generally understood by one of ordinary skill in the art. As described in the present disclosure, the terms used in the specification of the present disclosure are intended to describe example embodiments, instead of limiting the present disclosure. As used herein, the term “and/or” includes any and all combinations of one or more related listed items.

Exemplary embodiments will be described with reference to the accompanying drawings. In the case where there is no conflict between the exemplary embodiments, the features of the following embodiments and examples may be combined with each other.

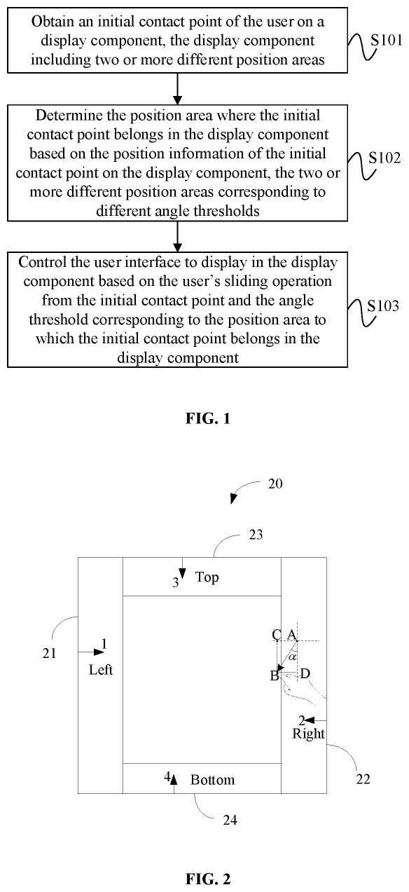

An embodiment of the present disclosure provides a method of displaying a user interface. FIG. 1 is a flowchart of a method of displaying a user interface according to an embodiment of the present disclosure. The method will be described in detail below.

S101, obtaining an initial contact point of the user on a display component, the display component including two or more different position areas.

FIG. 2 is a schematic diagram of a terminal device display component 20 according to an embodiment of the present disclosure. The terminal device may be a mobile phone, a tablet, a smart watch, a smart bracelet, a small camera, a miniature electronic product, etc. Correspondingly, the display component 20 may be a screen of the terminal device, and the screen may be a touch screen. It can be understood that if the terminal device is a smart watch, a smart bracelet, a small camera, a miniature electronic product, etc., the size of the display component 20 can be relatively small.

When the user controls the terminal device to display or switch the user interface through touch operation, the touch screen can sense the user's touch, slide, and other operations on the touch screen, and send the operation to a processor inside the terminal device. Based on the user operation, the processor can generate the corresponding control instruction to control the touch screen to display a corresponding user interface.

In some embodiments, when the user's finger touches the touch screen, the touch screen may detect the initial contact point of the user's finger on the touch screen, and send the relevant information of the initial contact point, such as the position information, to the processor.

S102, determining the position area where the initial contact point belongs in the display component based on the position information of the initial contact point on the display component, the two or more different position areas corresponding to different angle thresholds.

The processor may be configured to determine the location area to which the initial contact point belongs in the display component based on the position information of the initial contact point on the display component. As shown in FIG. 2, point A represents the initial contact point of the user on the display component 20. The processor connected to the display component may determine location area to which the initial contact point A belongs on the display component 20 based on the position of the initial contact point A on the display component 20. As shown in FIG. 2, the display component 20 includes two or more different position areas. For example, the display component 20 includes five different position areas, such as an upper area, a lower area, a left area, a right area, and a middle area. It can be understood that position areas provided above is merely an example, the number of different position areas and the division method are not limited in the embodiments of the present disclosure.

In some embodiments, different position areas in the display component may correspond to different angle thresholds. For example, the angle threshold corresponding to the upper area and the lower area of the display component may be 60°, the angle threshold corresponding to the left area and the right area of the display component may be 30°, and the angle threshold corresponding to the middle area of the display component may be 45°.

S103, controlling the user interface to display in the display component based on the user's sliding operation starting from the initial contact point and the angle threshold corresponding to the position area to which the initial contact point belongs in the display component.

In some embodiments, the processor may be configured to determine the user's sliding direction from the initial contact point A based on the user's sliding operation on the display component; determine a to-be-displayed user interface based on the sliding direction and the angle threshold corresponding to the position area to which the initial contact point A belongs; and control the user interface to display in the display component.

As shown in FIG. 2, the initial contact point A belongs to the right area of the display component, and the user's sliding direction on the display component is from the initial contact point A to the current contact point B. The angle between the sliding direction AB and the vertical direction is denoted as α. α can be compared with the angle threshold corresponding to the right area, such as 30°. If α is greater than or equal to 30°, it may indicate that the user interface to be displayed is the user interface on the left and right sides of the display component. That is, the user interface to be displayed can be called out from a left edge 21 or a right edge 22 of the display component. For example, the user interface can be called out from the left edge 21 of the display component along a direction 1 or the user interface can be called out from the right edge 22 of the display component along a direction 2.

If α is less than 30°, it may indicate that the user interface to be displayed is the user interface on the upper and lower sides of the display component. That is, the user interface to be displayed can be called out from an upper edge 23 or a lower edge 24 of the display component. For example, the user interface can be called out from the upper edge 23 of the display component along a direction 3 or the user interface can be called out from the lower edge 24 of the display component along a direction 4.

In some embodiments, when α is less than 30°, if the current contact point B is below the horizontal direction passing through the initial contact point A, the user interface to be displayed (or to-be-displayed user interface) may be determined to be called out along the direction 3 from the upper edge 23 of the display component. If the current contact point B is above the horizontal direction passing through the initial contact point A, the user interface to be displayed may be determined to be called out along the direction 4 from the lower edge 24 of the display component.

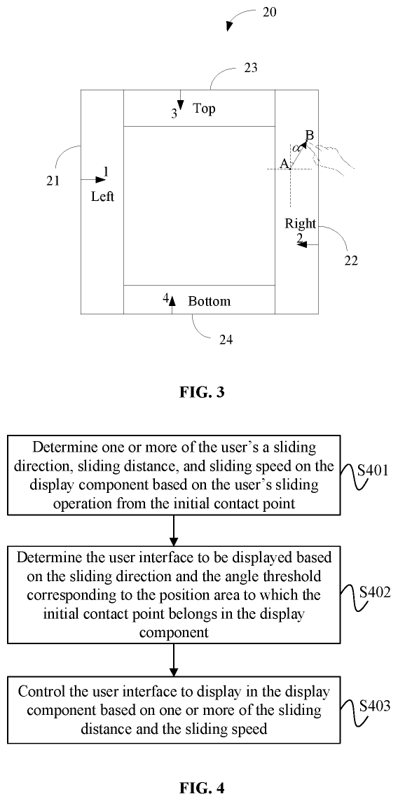

As shown in FIG. 2, α is less than 30°, the current contact point B is below the horizontal direction passing through the initial contact point A, and the user interface to be displayed is called out along the direction 3 from the upper edge 23 of the display component. As shown in FIG. 3, α is less than 30°, the current contact point B is above the horizontal direction passing through the initial contact point A, and the user interface to be displayed is called out along the direction 4 from the lower edge 24 of the display component

In other embodiments, when α is less than 30°, if the current contact point B is below of the horizontal direction passing through the initial contact point A, the user interface to be displayed may be determined to be called out along the direction 4 from the lower edge 24 of the display component. If the current contact point B is above of the horizontal direction passing through the initial contact point A, the user interface to be displayed may be determined to be called out along the direction 3 from the upper edge 23 of the display component.

Similarly, when α is greater than or equal to 30°, if the current contact point B is on the left side of the vertical direction passing through the initial contact point A, the user interface to be displayed may be determined to be called out along the direction 2 from the right edge 22 of the display component. If the current contact point B is on the right side of the vertical direction passing through the initial contact point A, the user interface to be displayed may be determined to be called out along the direction 1 from the left edge 21 of the display component.

In other embodiments, when α is greater than or equal to 30°, if the current contact point B is on the left side of the vertical direction passing through the initial contact point A, the user interface to be displayed may be determined to be called out along the direction 1 from the left edge 21 of the display component. If the current contact point B is on the right side of the vertical direction passing through the initial contact point A, the user interface to be displayed may be determined to be called out along the direction 2 from the right edge 22 of the display component.

That is, when the user's initial contact point A in the display component is positioned in the right area, based on the relationship between the user's sliding direction from the initial contact point A and the angle threshold corresponding to the right area, and the positional relationship of the current contact point B relative to the vertical or horizontal direction passing through the initial contact point A, the user interface to be displayed can be called out from the upper edge, the lower edge, the left edge, or the right edge of the display component.

Similarly, when the user's initial contact point A in the display component is positioned in another position area, such as the left area, the upper area, the lower area, or the middle area, the user interface to be displayed can also be called out from the upper edge, the lower edge, the left edge, or the right edge of the display component. In some embodiments, the user interfaces respectively called out from the upper edge, the lower edge, the left edge, and the right edge of the display component may be the same or different, which is not limited in the embodiments of the present disclosure.

In the embodiments of the present disclosure, the user's initial contact point on the display component can be obtained, and the position area to which the initial contact point belongs in the display component can be determined based on the position information of the initial contact point on the display component. Since the display component includes two or more different position areas, and the two or more different position areas correspond to different angle thresholds, therefore, based on the user's sliding operation starting from the initial contact point and the angle threshold corresponding to the position area to which the initial contact point belongs, the sliding operation can be accurately analyzed to determine the user interface that the user wishes to display or remove, thereby allowing the terminal device with a small scree to accurately display the user interface.

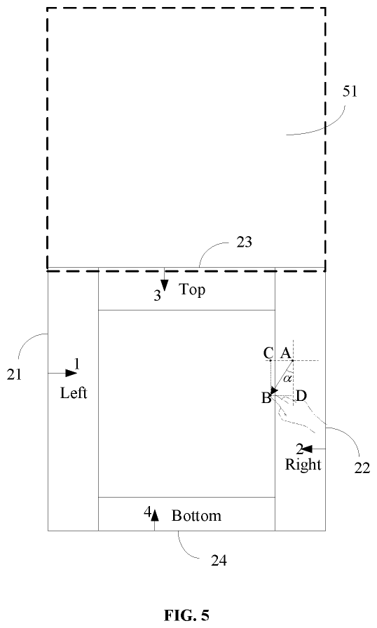

An embodiment of the present disclosure further provides a method of displaying a user interface. FIG. 4 is a flowchart of schematic diagram of the method of displaying the user interface according to another embodiment of the present disclosure. As shown in FIG. 4, based on the embodiment shown in FIG. 1, controlling the user interface to display in the display component based on the user's sliding operation starting from the initial contact point and the angle threshold corresponding to the position area to which the initial contact point belongs in the display component may include determining one or more of the user's a sliding direction, sliding distance, and sliding speed on the display component based on the user's sliding operation starting from the initial contact point (S401).

As shown in FIG. 2 or FIG. 3, the user starts sliding from the initial contact point A, and the display component 20 can detect in real time the user's sliding operation starting from the initial contact point A. The processor may determine one or more of the user's sliding direction, sliding distance, and sliding speed on the display component based on the user's sliding operation.

In some embodiments, determining one or more of the user's sliding direction, sliding distance, and sliding speed on the display component based on the user's sliding operation starting from the initial contact point may include determining the user's current contact point on the display component based on the user's sliding operation starting from the initial contact point; determining one or more of the user's sliding direction and sliding distance on the display component based on the current contact point and the initial contact point; and/or determining the user's sliding speed based on the current contact point, the initial contact point, and the time from the initial contact point to the current contact point.

For example, when the user starts to slide from the initial contact point A, the display component 20 can detect the user's contact points on the display component at different times in real time. It can be understood that the user's contact points at different times on the display component can constitute a sliding track starting from the initial contact point A. Correspondingly, the processor may determine the user's sliding direction and/or sliding distance on the display component based on the user's contact points and the initial contact point A at different times on the display component.

In some embodiments, the sliding direction may be a direction from the initial contact point to the current contact point.

In some embodiments, the sliding distance may be a linear distance of the current contact point relative to the initial contact point. Alternatively, the sliding distance may be a projection distance in a horizontal direction or a vertical direction of the linear distance of the current contact point relative to the initial contact point.

As shown in FIG. 2, the user's contact point on the display component at the current time is B, that is, the current contact point B. The processor can determine that the user's sliding direction on the display component at the current time is the direction from the initial contact point A to the current contact point B, and the sliding distance is the linear distance from the initial contact point A to the current contact point B based on the position information of the initial contact point A and the current contact point B. In other embodiments, the sliding distance may also be the horizontal project distance of the linear distance from the initial contact point A to the current contact point B, as shown in line AC in FIG. 2; or the sliding distance may also be the vertical project distance of the linear distance from the initial contact point A to the current contact point B, as shown in line AD in FIG. 2.

In addition, the processor may also determine the user's sliding speed based on the linear distance from the initial contact point A to the current contact point B, and the time the user slides from the initial contact point A to the current contact point B.

S402, determining the user interface to be displayed based on the sliding direction and the angle threshold corresponding to the position area to which the initial contact point belongs in the display component.

In this embodiment, the method of determining the user interface to be displayed based on the sliding direction and the angle threshold corresponding to the position area to which the initial contact point belongs in the display component may be consistent with the method described in the foregoing embodiment, which will not be repeated here.

In some embodiments, when the sliding distance is greater than a first distance threshold, the user interface to be displayed may be determined based on the sliding direction and the angle threshold corresponding to the position area to which the initial contact point belongs in the display component.

For example, when the linear distance from the initial contact point A to the current contact point B is greater than the first distance threshold, the user interface to be displayed can be determined based on the sliding direction and the angle threshold corresponding to the position area to which the initial contact point belongs in the display component.

In other embodiments, when the horizontal project distance AC of the linear distance from the initial contact point A to the current contact point B is greater than the first distance threshold, or when the vertical projection distance AD of the linear distance from the initial contact point A to the current contact point B is greater than the first distance threshold, the user interface to be displayed can be determined based on the sliding direction and the angle threshold corresponding to the position area to which the initial contact point belongs in the display component.

In some embodiments, the user interface to be displayed may be a user interface called out from the upper edge, lower edge, left edge, or right edge of the display component.

S403, controlling the user interface to display in the display component based on one or more of the sliding distance and the sliding speed.

When the processor determines the user interface to be displayed, the user interface to be displayed can be controlled to be displayed in the display component based on one or more of the current sliding distance and the current sliding speed.

In some embodiments, controlling the user interface to display in the display component based on one or more of the sliding distance and the sliding speed may include controlling the user interface to display in the display component based on the sliding distance.

As shown in FIG. 2, when α is less than 30°, and the sliding distance is greater than the first distance threshold, such as 40 pixels, the user interface to be displayed can be controlled to be called out along the direction 3 from the upper edge 23 of the display component. If α is greater than 30°, and the sliding distance is greater than the first distance threshold, such as 40 pixels, the user interface to be displayed can be controlled to be called out along the direction 2 from the right edge 22 of the display component.

In some embodiments, when the sliding speed is greater than or equal to a speed threshold, the complete page of the user interface to be displayed can be controlled to be displayed in the display component; and when the sliding speed is less than the speed threshold, the user interface can be controlled to be displayed in the display component based on the sliding distance.

As shown in FIG. 2, if the user's sliding speed from the initial contact point A to the current contact point B is greater than or equal to the speed threshold, the process may control the display component to display the complete page of the user interface to be displayed determined in the previous processes. That is, when the user's sliding speed on the display component is fast enough, the user interface to be displayed can be all called out in the display component. If the user's sliding speed from the initial contact point A to the current contact point B is less than the speed threshold, that is, when the user's sliding speed on the display component is not fast enough, the processor may control the user interface to be displayed to be displayed based on the sliding distance from the initial contact point A to the current contact point B.

In some embodiments, when the sliding distance is greater than the first distance threshold and the sliding speed is greater than or equal to the speed threshold, the complete page of the user interface can be controlled to be displayed in the display component; and when the sliding distance is greater than the first distance threshold and the sliding speed is less than the speed threshold, the user interface can be controlled to be displayed in the display component.

As shown in FIG. 2, if the sliding distance from the initial contact point A to the current contact point B is greater than the first distance threshold, and the user's sliding speed from the initial contact point A to the current contact point B is greater than or equal to the speed threshold, then the processor can control the display component to display the complete page of the user interface to be displayed determined in the previous processes. If the sliding distance from the initial contact point A to the current contact point B is greater than the first distance threshold, and the user's sliding speed from the initial contact point A to the current contact point B is less than the speed threshold, then the processor can control the display of the user interface to be displayed based on the sliding distance from the initial contact point A to the current contact point B.

In addition, the method may further include controlling the edge of the user interface to be displayed in the display component when the sliding distance is substantially equal to the first distance threshold.

As shown in FIG. 5, take the sliding distance as the linear distance from the initial contact point A to the current contact point B as an example, if α is less than 30°, the user interface to be displayed can be called out along the direction 3 from the upper edge 23 of the display component. In some embodiments, when the sliding distance is substantially equal to the first distance threshold, such as 40 pixels, the edge of the user interface can be controlled to be displayed in the display component. For example, when the linear distance from the initial contact point A to the current contact point B is equal to 40 pixels, an edge of a to-be-displayed user interface 51, such as the lower edge, can be displayed in the display component.

In some embodiments, when the sliding distance is substantially equal to the first distance threshold, part of the page of the user interface can be controlled to be displayed in a preset area around the current contact point in the display component.

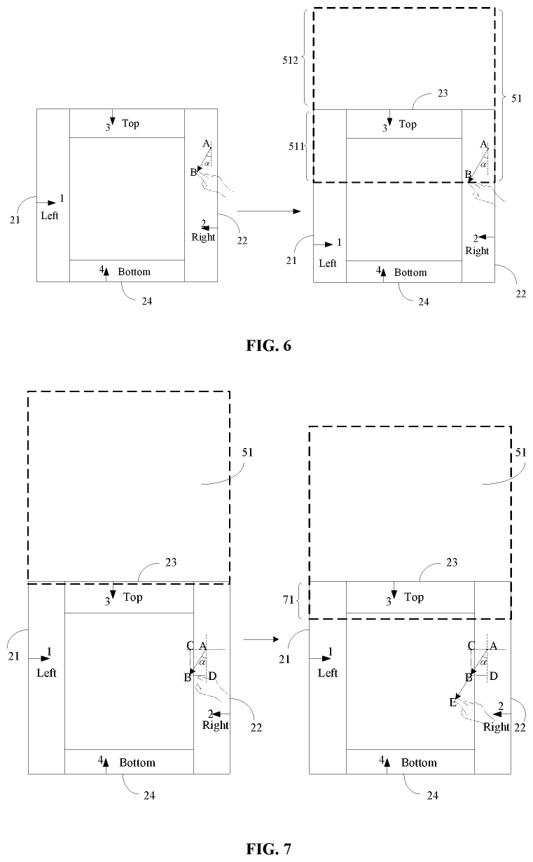

As shown in FIG. 6, take the sliding distance as the linear distance from the initial contact point A to the current contact point B as an example, if α is less than 30°, the to-be-displayed user interface 51 can be called out along the direction 3 from the upper edge 23 of the display component. In some embodiments, when the sliding distance is less than the first distance threshold, such as 40 pixels, the to-be-displayed user interface 51 may not be displayed in the display component. When the sliding distance is substantially equal to the first distance threshold, such as 40 pixels, the to-be-displayed user interface 51 may be called out along the direction 3 from the upper edge 23 of the display component, and part of the page of the to-be-displayed user interface 51 may be displayed in the display component, and the remaining part may not be displayed in the display component. For example, 511 indicates a part of the page of the to-be-displayed user interface 51 displayed in the display component, and 512 indicates a part of the page of the to-be-displayed user interface 51 that is not displayed. In some embodiments, part of the page of the to-be-displayed user interface 51 displayed in the display component may be positioned in a preset area around the current contact point B. For example, the lower edge of the to-be-displayed user interface 51 can be called out to the position of the current contact point B. That is, when the sliding distance is substantially equal to the first distance threshold, such as 40 pixels, the to-be-displayed user interface 51 can be called out to the position of the user's finger on the screen.

In some embodiments, controlling the user interface to be displayed in the display component based on the sliding distance may include controlling a part of the page of the user interface to be displayed in the display component when the sliding distance is greater than the first distance threshold and less than or equal to a second distance threshold; and controlling the complete page of the user interface to be displayed in the display component when the sliding distance is greater than the second distance threshold. In some embodiments, the first distance threshold may be less than the second distance threshold.

In some embodiments, controlling a part of the page of the user interface to be displayed in the display component when the sliding distance is greater than the first distance threshold and less than or equal to the second distance threshold may include controlling the part of the page of the user interface to change based on the change of the position of the current contact point in the display component when the sliding distance is greater than the first distance threshold and less than or equal to the second distance threshold.

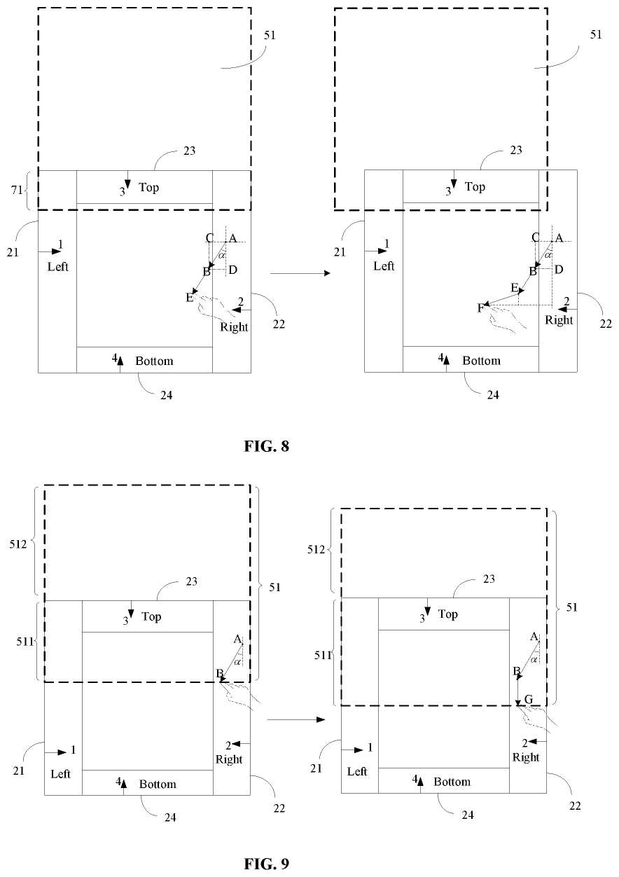

As shown in FIG. 5, when the user slides from the initial contact point A to the current contact point B, the edge of the to-be-displayed user interface 51 can be displayed in the display component, and the user may also continue to slide based on the current contact point B. The direction of the continued slide may be the same as the direction from A to B, or it may be in a different direction. As shown in FIG. 7, the user continues to slide in the direction from A to B to point E. If the sliding distance for the initial contact point A to point E is greater than 40 pixels and less than or equal to the second distance threshold, such as 80 pixels, then a part of the page of the user interface 51 can be controlled to be displayed in the display component. In some embodiments, the part of the user interface 51 may follow the change of the position of the user's finger in the display component. For example, the farther the current contact point E is from the initial contact point A, the larger a partial page 71 of the user interface 51 can be displayed in the display component; or the greater the projection distance in the vertical direction of the linear distance of the current contact point E relative to the initial contact point A or point B, the larger the partial page 71 of the user interface 51 can be displayed in the display component. In addition, when the user's sliding direction changes, part of the page of the user interface 51 displayed in the display component may also change. As shown in FIG. 8, when the user slides from the contact point E to point F, since the linear distance of the current contact point F and the contact point E in the horizontal direction is greater than the projection distance of the linear distance in the vertical direction, or the linear distance of the current contact point F relative to the initial contact point A in the horizontal direction is greater than a preset threshold, then the part of the page of the user interface 51 that has been displayed may move in the horizontal direction, thereby causing the part of the page of the user interface 51 that has been displayed to become smaller.

In addition, if the sliding distance from the initial contact point A to the current contact point F is greater than the second distance threshold, such as 80 pixels, the complete page of the user interface 51 can be controlled to be displayed in the display component. That is, when the linear distance from the initial contact point A to the current contact point F, or the projection distance of the linear distance in the horizontal direction or the vertical direction is greater than 80 pixels, the complete page of the user interface 51 can be controlled to be displayed in the display component.

In some embodiments, controlling a part of the page of the user interface to change following the change of the position of the current contact point in the display component may include controlling the size of the part of the page of the user interface to change following the change of the position of the current contact point in the display component.

As shown in FIG. 6, when the sliding distance from the initial contact point A to the current contact point B is equal to 40 pixels, the lower edge of the user interface 51 is called out to the position of the current contact point B. When the current contact point changes, part of the page of the user interface 51 that has been displayed in the display component may also change. As shown in FIG. 9, the user slides from the contact B to a point G, and the lower edge of the user interface 51 follows the user's finger to move to the position where point G is positioned, such that a partial page 511 of the user interface 51 displayed in the display component becomes larger.

In some embodiments, controlling a part of the page of the user interface to change following the change of the position of the current contact point in the display component may include controlling the position of the part of the page of the user interface in the display component to change following the change of the position of the current contact point in the display component.

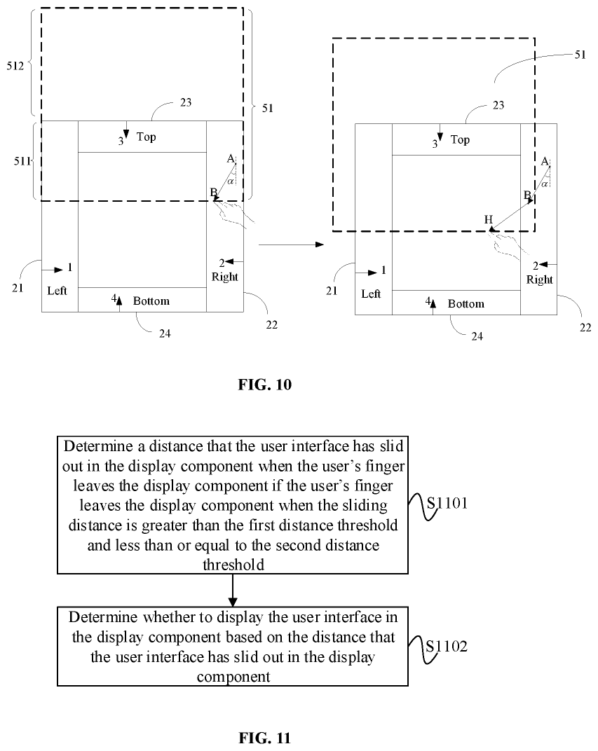

As shown in FIG. 10, the user slides from the contact B to a point H. The linear distance between the point H and the point B can have a projection distance in the horizontal direction and a projection distance in the vertical direction. Therefore, based on the embodiment shown in FIG. 6, the user interface 51 can be controlled to move in the vertical direction and the horizontal direction at the same time, for example, the user interface 51 can be controlled to move to the right while moving down.

In the embodiments of the present disclosure, when the sliding distance is greater than the first distance threshold and less than or equal to the second distance threshold, a part of the page of the user interface can be controlled to change following the change of the position of the current contact point in the display component. In this way, the size or position of a part of the page of the user interface can change following the change of the position of the current contact point in the display component. That is, the user interface can be controlled to follow the movement of the user's finger in the display component, which improves the flexibility of the user interface display.

An embodiment of the present disclosure provides a user interface display method. FIG. 11 is a flowchart of schematic diagram of a method of displaying a user interface according to another embodiment of the present disclosure. The method will be described in detail below.

S1101, determining a distance that the user interface has slid out in the display component when the user's finger leaves the display component if the user's finger leaves the display component when the sliding distance is greater than the first distance threshold and less than or equal to the second distance threshold.

As shown in FIG. 10, the sliding distance from the initial contact point A to the current contact point H is greater than 40 pixels and less than or equal to 80 pixels. If the user's finger leaves the display component from the current contact point H, the distance that the user interface 51 has slid out in the display component when the finger leaves the display component can be determined. The distance may be the vertical distance between the lower edge of the user interface 51 and the upper edge 23 of the display component.

S1102, determining whether to display the user interface in the display component based on the distance that the user interface has slid out in the display component.

For example, whether to display the user interface in the display component can be determined based on the vertical distance between the lower edge of the user interface 51 and the upper edge 23 of the display component.

In some embodiments, determining whether to display the user interface in the display component based on the distance that the user interface has slid out in the display component may include controlling the complete page of the user interface to be displayed in the display component if the distance that the user interface has slid out in the display component is greater than or equal to a third distance threshold; and controlling the user interface not to be displayed in the display component if the distance that the user interface has slid out in the display component is less than the third distance threshold.

As shown in FIG. 10, when the user's finger leaves the display component from the current contact point H, if the vertical distance between the lower edge of the user interface 51 and the upper edge 23 of the display component is greater than or equal to the third distance threshold, then the user interface 51 can be controlled to be completely displayed in the display component. If the vertical distance between the lower edge of the user interface 51 and the upper edge 23 of the display component is less than the third distance threshold, then the user interface 51, then the user interface 51 can be controlled not to be displayed in the display component, that is, the user interface 51 can be controlled to return to the initial hidden position. In some embodiments, the third distance threshold may be a value between 40 pixels and 80 pixels.

In addition, if the sliding distance from the initial contact point A to the current contact point H is greater than 80 pixels, even if the user' finger leaves the display component from the current contact point H, the user interface 51 may also be controlled to be completely displayed in the display component.

In this embodiment, when the user's finger leaves the display component, if the sliding distance is greater than the first distance threshold and less than or equal to the second distance threshold, the distance of which the user interface has slid out in the display component when the user's finger leaves the display component can be determined. Subsequently, based on the distance that the user interface has slid out in the display component, whether to display the user interface in the display component can be determined. When the distance that the user interface has slid out in the display component is greater than the third distance threshold, the complete page of the user interface can be controlled to be displayed in the display component. When the distance that the user interface has slid out in the display component is less than the third distance threshold, the user interface can be controlled to return to the initial hidden position, which further improves the flexibility of the user interface display.

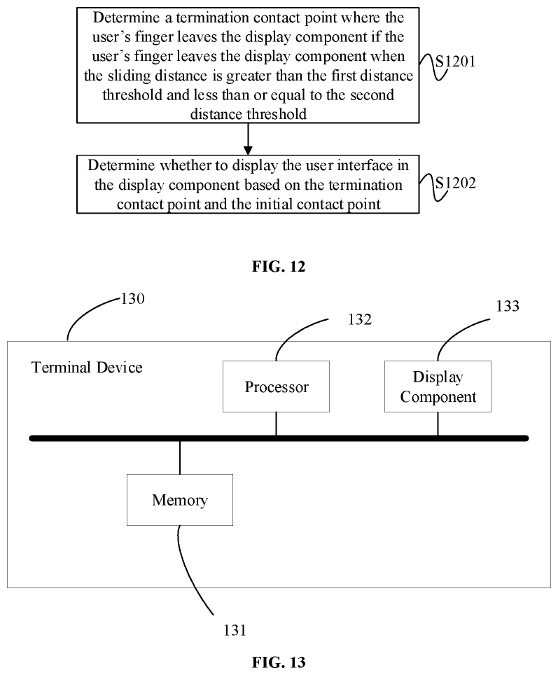

An embodiment of the present disclosure provides a user interface display method. FIG. 12 is a flowchart of schematic diagram of a method of displaying a user interface according to another embodiment of the present disclosure. The method will be described in detail below.

S1201, determining a termination contact point where the user's finger leaves the display component if the user's finger leaves the display component when the sliding distance is greater than the first distance threshold and less than or equal to the second distance threshold.

As shown in FIG. 10, the sliding distance from the initial contact point A to the current contact point H is greater than 40 pixels and less than or equal to 80 pixels. If the user's finger leaves the display component from the current contact point H, the termination contact point when the finger leaves the display component can be determined as point H.

S1202, determining whether to display the user interface in the display component based on the termination contact point and the initial contact point.

For example, whether to display the user interface 51 in the display component can be determined based on the termination contact point H and the initial contact point A.

In some embodiments, determining whether to display the user interface in the display component based on the termination contact point and the initial contact point may include controlling the complete page of the user interface to be displayed in the display component if the sliding distance of the termination contact point relative to the initial contact point is greater than or equal to a fourth distance threshold; and controlling the user interface not to be displayed in the display component if the sliding distance of the termination contact point relative to the initial contact point is less than the fourth distance threshold. In some embodiments, the fourth distance threshold may be greater than the first distance threshold and less than the second distance threshold.

More specifically, the sliding distance of the termination contact point H relative to the initial contact point A may be determined based on the position information of the termination contact point H and the initial contact point A.

In some embodiments, the sliding distance of the termination contact point relative to the initial contact point may be the linear distance of the termination contact point relative to the initial contact point. For example, the sliding distance of the termination contact point H relative to the initial contact point A may be the linear distance of the termination contact point H relative to the initial contact point A.

Alternatively, the sliding distance of the termination contact point relative to the initial contact point may be the projection distance of the linear distance of the termination contact point relative to the initial contact point in the horizontal direction or the vertical direction. For example, the sliding distance of the termination contact point H relative to the initial contact point A may be the projection distance of the linear distance of the termination contact point H relative to the initial contact point A in the horizontal direction or the vertical direction.

When the sliding distance of the termination contact point H relative to the initial contact point A is greater than or equal to the fourth distance threshold, the user interface 51 can be controlled to be completely displayed in the display component. When the sliding distance of the termination contact point H relative to the initial contact point A is less than the fourth distance threshold, the user interface 51 can be controlled not to be displayed in the display component, that is, the user interface 51 can be controlled to return to the initial hidden position. In some embodiments, the fourth distance threshold may be a value between 40 pixels and 80 pixels.

In this embodiment, when the user's finger leaves the display component, if the sliding distance is greater than the first distance threshold and less than or equal to the second distance threshold, then the termination contact point when the user's finger leaves the display component can be determined. Based on the sliding distance of the termination contact point relative to the initial contact point, whether to display the user interface in the display component can be determined. If the sliding distance of the termination contact point relative to the initial contact point is greater than or equal to the fourth distance threshold, the user interface can be controlled to be completely displayed in the display component. If the sliding distance of the termination contact point relative to the initial contact point is less than the fourth distance threshold, the user interface can be controlled to return to the initial hidden position, which further improves the flexibility of the user interface display.

An embodiment of the present disclosure further provides a terminal device. FIG. 13 is a structural diagram of a terminal device according to an embodiment of the present disclosure. As shown in FIG. 13, a terminal device 130 includes a memory 131, a processor 132, and a display component 133. The memory 131 can be configured to store program instructions. The processor 132 can be configured to execute the program instructions stored in the memory 131. When executed by the processor 132, the program instructions can cause the processor 132 to obtain an initial contact point of the user on a display component, the display component including two or more different position areas; determine the position area where the initial contact point belongs in the display component based on the position information of the initial contact point on the display component, the two or more different position areas corresponding to different angle thresholds; and control the user interface to display in the display component based on the user's sliding operation starting from the initial contact point and the angle threshold corresponding to the position area to which the initial contact point belongs in the display component.

In some embodiments, when controlling the user interface to display in the display component based on the user's sliding operation starting from the initial contact point and the angle threshold corresponding to the position area to which the initial contact point belongs in the display component, the processor 132 may be configured to determine one or more of the user's a sliding direction, sliding distance, and sliding speed on the display component based on the user's sliding operation starting from the initial contact point; determine the user interface to be displayed based on the sliding direction and the angle threshold corresponding to the position area to which the initial contact point belongs in the display component; and control the user interface to display in the display component based on one or more of the sliding distance and the sliding speed.

In some embodiments, when determining one or more of the user's a sliding direction, sliding distance, and sliding speed on the display component based on the user's sliding operation starting from the initial contact point, the processor 132 may be configured to determine the user's current contact point on the display component based on the user's sliding operation starting from the initial contact point; determine one or more of the user's sliding direction and sliding distance on the display component based on the current contact point and the initial contact point; and/or determine the user's sliding speed based on the current contact point, the initial contact point, and the time from the initial contact point to the current contact point.

In some embodiments, the sliding direction may be a direction from the initial contact point to the current contact point. In some embodiments, when determining the user interface to be displayed based on the sliding direction and the angle threshold corresponding to the position area to which the initial contact point belongs in the display component, the processor 132 may be configured to determine the user interface to be displayed based on the sliding direction and the angle threshold corresponding to the position area to which the initial contact point belongs in the display component when the sliding distance is greater than a first distance threshold.

In some embodiments, when controlling the user interface to display in the display component based on one or more of the sliding distance and the sliding speed, the processor 132 may be configured to control the user interface to display in the display component based on the sliding distance.

In some embodiments, when controlling the user interface to display in the display component based on one or more of the sliding distance and the sliding speed, the processor 132 may be configured to control the complete page of the user interface to display in the display component when the sliding speed is greater than or equal to the speed threshold; and control the user interface to display in the display component based on the sliding distance when the sliding speed is less than the speed threshold.

In some embodiments, when controlling the user interface to display in the display component 133 based on one or more of the sliding distance and the sliding speed, the processor 132 may be configured to control the complete page of the user interface can be controlled to be displayed in the display component when the sliding distance is greater than the first distance threshold and the sliding speed is greater than or equal to the speed threshold; and control the user interface to display in the display component 133 when the sliding distance is greater than the first distance threshold and the sliding speed is less than the speed threshold.

In some embodiments, when controlling the user interface to display in the display component based on the sliding distance, the processor 132 may be configured to control a part of the page of the user interface to display in the display component when the sliding distance is greater than the first distance threshold and less than or equal to a second distance threshold; and control the complete page of the user interface to display in the display component when the sliding distance is greater than the second distance threshold. In some embodiments, the first distance threshold may be less than the second distance threshold.

In some embodiments, when controlling a part of the page of the user interface to display in the display component, the processor 132 may be configured to control the part of the page of the user interface to change based on the change of the position of the current contact point in the display component.

In some embodiments, when controlling the part of the page of the user interface to change based on the change of the position of the current contact point in the display component, the processor 132 may be configured to control the size of the part of the page of the user interface to change following the change of the position of the current contact point in the display component.

In some embodiments, when controlling the part of the page of the user interface to change based on the change of the position of the current contact point in the display component, the processor 132 may be configured to control the position of the part of the page of the user interface in the display component to change following the change of the position of the current contact point in the display component.

In some embodiments, the processor 132 may be further configured to control the edge of the user interface to be displayed in the display component when the sliding distance is substantially equal to the first distance threshold.

In some embodiments, the processor 132 may be further configured to control part of the page of the user interface to be displayed in a preset area around the current contact point in the display component 133 when the sliding distance is substantially equal to the first distance threshold.

In some embodiments, the processor 132 may be further configured to determine a distance that the user interface has slid out in the display component when the user's finger leaves the display component if the user's finger leaves the display component when the sliding distance is greater than the first distance threshold and less than or equal to the second distance threshold; and determine whether to display the user interface in the display component based on the distance that the user interface has slid out in the display component.

In some embodiments, when determining whether to display the user interface in the display component based on the distance that the user interface has slid out in the display component, the processor 132 may be configured to control the complete page of the user interface to be displayed in the display component if the distance that the user interface has slid out in the display component is greater than or equal to a third distance threshold; and control the user interface not to be displayed in the display component if the distance that the user interface has slid out in the display component is less than the third distance threshold.

In some embodiments, the sliding distance may be the linear distance of the current contact point relative to the initial contact point.

In some embodiments, the sliding distance may be the projection distance of the linear distance of the current contact point relative to the initial contact point in the horizontal direction or the vertical direction.

In some embodiments, the processor 132 may be further configured to determine a termination contact point where the user's finger leaves the display component if the user's finger leaves the display component when the sliding distance is greater than the first distance threshold and less than or equal to the second distance threshold; and determine whether to display the user interface in the display component based on the termination contact point and the initial contact point.

In some embodiments, when determining whether to display the user interface in the display component based on the termination contact point and the initial contact point, the processor 132 may be configured to control the complete page of the user interface to be displayed in the display component if the sliding distance of the termination contact point relative to the initial contact point is greater than or equal to a fourth distance threshold; and control the user interface not to be displayed in the display component if the sliding distance of the termination contact point relative to the initial contact point is less than the fourth distance threshold. In some embodiments, the fourth distance threshold may be greater than the first distance threshold and less than the second distance threshold

In some embodiments, the sliding distance of the termination contact point relative to the initial contact point may be the linear distance of the termination contact point relative to the initial contact point.

In some embodiments, the sliding distance of the termination contact point relative to the initial contact point may be projection distance of the linear distance of the termination contact point relative to the initial contact point in the horizontal direction or the vertical direction.

The specific principles and implementation methods of the terminal device provided in the embodiments of the present disclosure are similar to the foregoing embodiments, which will not be repeated here.

In the embodiments of the present disclosure, the user's initial contact point on the display component can be obtained, and the position area to which the initial contact point belongs in the display component can be determined based on the position information of the initial contact point on the display component. Since the display component includes two or more different position areas, and the two or more different position areas correspond to different angle thresholds, therefore, based on the user's sliding operation starting from the initial contact point and the angle threshold corresponding to the position area to which the initial contact point belongs, the sliding operation can be accurately analyzed to determine the user interface that the user wishes to display or remove, thereby allowing the terminal device with a small scree to accurately display the user interface.

In addition, an embodiment of the present disclosure further provides a computer-readable storage medium storing a computer program. The computer program can be executed by a processor to implement the user interface display method described in the foregoing embodiments.

In the several embodiments provided by the present disclosure, it should be understood that the disclosed apparatus and method may be implemented in other manners. For example, the apparatus embodiments described above are merely illustrative. For example, the unit division is merely logical function division and there may be other division in actual implementation. For example, multiple units or components may be combined or integrated into another system, or some features can be omitted or not be executed. In addition, the mutual coupling or the direct coupling or the communication connection as shown or discussed may be indirect coupling or communication connection through some interfaces, devices or units, and may be in electrical, mechanical or other forms.

The units described as separate components may or may not be physically separated. The components displayed as units may or may not be physical units, that is, may be located in one place or may also be distributed to multiple network units. Some or all of the units may be selected according to actual needs to achieve the objectives of the solution in the disclosure.

In addition, each functional unit in each embodiment of the present disclosure may be integrated into one processing unit, or each unit may exist alone physically, or two or more units may be integrated in one unit. The above-mentioned integrated unit can be implemented in the form of hardware or in the form of hardware plus software functional unit.

The above-described integrated unit implemented in the form of a software functional unit may be stored in a computer-readable storage medium. The software function unit is stored in a storage medium and includes several instructions for enabling a computer device (which may be a personal computer, a server, a network device, etc.) or a processor to execute some steps of the method according to each embodiment of the present disclosure. The foregoing storage medium includes a medium capable of storing program code, such as a USB flash disk, a removable hard disk, a read-only memory (ROM), a random access memory (RAM), a magnetic disk, an optical disc, or the like.

Those skilled in the art may clearly understand that, for convenience and brevity of description, the division of the foregoing functional modules is only used as an example. In practical applications, however, the above function allocation may be performed by different functional modules according to actual needs. That is, the internal structure of the device is divided into different functional modules to accomplish all or part of the functions described above. For the working process of the foregoing apparatus, reference may be made to the corresponding process in the foregoing method embodiments, and details are not described herein again.

Finally, it should be noted that the foregoing embodiments are merely intended for describing the technical solutions of the present disclosure, but not to limit the present disclosure. Although the present disclosure is described in detail with reference to the foregoing embodiments, it should be understood by those of ordinary skill in the art that the technical solutions described in the foregoing embodiments may still be modified, or a part or all of the technical features may be equivalently replaced without departing from the spirit and scope of the present disclosure. As a result, these modifications or replacements do not make the essence of the corresponding technical solutions depart from the scope of the technical solutions of the present disclosure.

What is claimed is:

1. A method of displaying a user interface, comprising:
obtaining an initial contact point of a user on a display component, the display component including two or more different position areas;
determining a position area to which the initial contact point belongs in the display component based on position information of the initial contact point on the display component, the two or more different position areas corresponding to different angle thresholds; and
controlling the user interface to display in the display component, based on a sliding operation of the user starting from the initial contact point and an angle threshold corresponding to the position area to which the initial contact point belongs in the display component.

2. The method of claim 1, wherein controlling the user interface to display in the display component includes:
determining one or more of a sliding direction, a sliding distance, and a sliding speed of the user on the display component based on the sliding operation of the user starting from the initial contact point;
determining a to-be-displayed user interface based on the sliding direction and the angle threshold corresponding to the position area to which the initial contact point belongs in the display component; and
controlling the user interface to display in the display component based on one or more of the sliding distance and the sliding speed.

3. The method of claim 2, wherein determining one or more of the sliding direction, sliding distance, and sliding speed of the user on the display component based on the sliding operation of the user starting from the initial contact point includes:
determining a current contact point of the user on the display component based on the sliding operation of the user starting from the initial contact point;
determining one or more of the sliding direction and the sliding distance of the user on the display component based on the current contact point and the initial contact point; and/or
determining the sliding speed based on the current contact point, the initial contact point, and a time from the initial contact point to the current contact point.

4. The method of claim 3, wherein:
the sliding direction is a direction from the initial contact point to the current contact point.

5. The method of claim 2, wherein determining the to-be-displayed user interface based on the sliding direction and the angle threshold corresponding to the position area to which the initial contact point belongs in the display component includes:
determining the to-be-displayed user interface based on the sliding direction and the angle threshold corresponding to the position area to which the initial contact point belongs in the display component when the sliding distance is greater than a first distance threshold.

6. The method of claim 2, wherein controlling the user interface to display in the display component based on one or more of the sliding distance and the sliding speed includes:
controlling the user interface to display in the display component based on the sliding distance.

7. The method of claim 2, wherein controlling the user interface to display in the display component based on one or more of the sliding distance and the sliding speed includes:
controlling a complete page of the user interface to display in the display component when the sliding speed is greater than or equal to a speed threshold; and
controlling the user interface to display in the display component based on the sliding distance when the sliding speed is less than the speed threshold.

8. The method of claim 2, wherein controlling the user interface to display in the display component based on one or more of the sliding distance and the sliding speed includes:
controlling a complete page of the user interface to display in the display component when the sliding distance is greater than the first distance threshold and the sliding speed is greater than or equal to a speed threshold; and
controlling the user interface to display in the display component based on the sliding distance when the sliding distance is greater than the first distance threshold and the sliding speed is less than the speed threshold.

9. The method of claim 6, wherein controlling the user interface to display in the display component based on the sliding distance includes:
controlling part of the page of the user interface to display in the display component when the sliding distance is greater than the first distance threshold and less than or equal to a second distance threshold; and
controlling a complete page of the user interface to display in the display component when the sliding distance is greater than the second distance threshold, the first distance threshold being less than the second distance threshold.

10. The method of claim 9, wherein controlling part of the page of the user interface to display in the display component when the sliding distance is greater than the first distance threshold and less than or equal to the second distance threshold includes:
controlling the part of the page of the user interface to change, following a change of a position of the current contact point in the display component, when the sliding distance is greater than the first distance threshold and less than or equal to the second distance threshold.

11. The method of claim 10, wherein controlling the part of the page of the user interface to change, following the change of the position of the current contact point in the display component includes:
controlling a size of the part of the page of the user interface to change, following the change of the position of the current contact point in the display component.

12. The method of claim 10, wherein controlling the part of the page of the user interface to change, following the change of the position of the current contact point in the display component includes:
controlling a position of the part of the page of the user interface in the display component to change, following the change of the position of the current contact point in the display component.

13. The method of claim 9 further comprising:
controlling an edge of the user interface to display in the display component when the sliding distance is substantially equal to the first distance threshold.

14. The method of claim 9 further comprising:
controlling the part of the page of the user interface to display in a preset area around the current contact point in the display component when the sliding distance is substantially equal to the first distance threshold.

15. The method of claim 10 further comprising:
if a finger of the user leaves the display component, determining a distance of the user interface has slid out in the display component when the user's finger leaves the display component when the sliding distance is greater than the first distance threshold and less than or equal to the second distance threshold; and
determining whether to display the user interface in the display component based on the distance that the user interface has slid out in the display component.

16. The method of claim 15, wherein determining whether to display the user interface in the display component based on the distance that the user interface has slid out in the display component includes:
controlling the complete page of the user interface to display in the display component if the distance that the user interface has slid out is greater than or equal to a third distance threshold; and
controlling the user interface not to display in the display component if the distance that the user interface has slid out in the display component is less than the third distance threshold.

17. The method of claim 3, wherein:
the sliding distance is a linear distance of the current contact point relative to the initial contact point.

18. The method of claim 3, wherein:
the sliding distance is a projection distance of the linear distance of the current contact point relative to the initial contact point in a horizontal direction or a vertical direction.

19. A terminal device comprising:
a display component;
a processor; and
a memory storing program instructions that, when being executed by the processor, cause the processor to
obtain an initial contact point of a user on a display component, the display component including two or more position areas;
determine a position area to which the initial contact point belongs in the display component based on position information of the initial contact point on the display component, the two or more different position areas corresponding to different angle thresholds; and
control the user interface to display in the display component, based on a sliding operation of the user starting from the initial contact point and an angle threshold corresponding to the position area to which the initial contact point belongs in the display component.

20. A non-transitory computer-readable storage medium comprising:
a computer program stored therein, and when being executed by the processor, configured to cause the processor to
obtain an initial contact point of a user on a display component, the display component including two or more position areas;
determine a position area to which the initial contact point belongs in the display component based on position information of the initial contact point on the display component, the two or more different position areas corresponding to different angle thresholds; and
control the user interface to display in the display component, based on a sliding operation of the user starting from the initial contact point and the angle threshold corresponding to the position area to which the initial contact point belongs in the display component.
